(19) United States
(12) Patent Application Publication
(10) Pub. No.: US 2024/0095491 A1
(43) Pub. Date: Mar. 21, 2024

(54) METHOD AND SYSTEM FOR PERSONALIZED MULTIMODAL RESPONSE GENERATION THROUGH VIRTUAL AGENTS

(71) Applicant: Quantiphi, Inc., Marlborough, MA (US)

(72) Inventors: Dagnachew Birru, Marlborough, MA (US); Saisubramaniam Gopalakrishnan, Mumbai (IN); Siva Prasad Sompalli, Mumbai (IN); Varun V, Mumbai (IN); Vishal Vaddina, Toronto (CA)

(21) Appl. No.: 18/527,077

(22) Filed: Dec. 1, 2023

(51) Int. Cl. G06N 3/006; G06N 3/0455; G06N 3/0475; G10L 15/06; G10L 15/183; G10L 15/22; H04L 51/02

(52) U.S. Cl. CPC G06N 3/006; G06N 3/0455; G06N 3/0475; G10L 15/063; G10L 15/183; G10L 15/22; H04L 51/02

(57) ABSTRACT

A method and system for multimodal response generation through a virtual agent is provided herein. The method comprises retrieving information related to an input received by the virtual agent. The virtual agent employs an Artificial Intelligence (AI) model. The method further comprises generating a response corresponding to the input based on the retrieved information. The method may further comprises generating a plurality of prompts based on user characteristics and the input. The method may further comprises modifying the response based on the plurality of prompts to generate a multimodal response.

### TECHNICAL FIELD OF THE INVENTION

The present disclosure is related to multimodal interactions, and more particularly to a method and a system for personalized multimodal response generation through a virtual agent using Artificial Intelligence (AI) models.

### BACKGROUND OF THE INVENTION

In today's digital age, virtual agents and AI-powered systems have become increasingly integrated into our daily lives. These virtual agents are designed to understand and respond to user inputs, making them valuable tools for a wide range of applications, from customer service chatbots to virtual assistants in smart devices.

Traditionally, virtual agents and chatbots have relied heavily on text-based inputs and rule-based systems. These systems use predefined decision trees and scripts to generate responses to user queries. While they have been effective for simple tasks like information retrieval or basic customer support, they have significant limitations when it comes to handling more complex, natural language interactions.

With the advent of AI and Natural Language Processing (NLP), some advancements have been made in virtual agent technology. Large Language Models (LLMs), such as GPT-3 and GPT-4, have demonstrated impressive capabilities in understanding and generating human-like text. These models have been integrated into virtual agents, allowing them to provide more contextually relevant responses to text-based queries.

However, these existing techniques primarily focus on text-based interactions, and their ability to handle other modalities like speech, sensor data, or visual inputs is limited. Furthermore, they often lack the ability to understand user emotions and adapt their responses accordingly. These limitations result in less engaging and less effective user-agent interactions.

Therefore, in order to overcome the aforementioned problems, there exists a need for techniques that effectively utilize LLMs and multimodality to create personalized virtual agents across various modalities, including text, speech, and vision. These virtual agents not only understand user inputs across various modalities but also engage in reasoning and respond with a high degree of personalization. Such techniques enable virtual agents to be more adaptive, empathetic, and proficient in delivering responses that cater to users' unique needs and preferences.

It is within this context that the present embodiments arise.

### SUMMARY

The following embodiments present a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide a method for multimodal response generation through a virtual agent, the method comprising retrieving information related to an input received by the virtual agent. The virtual agent employs an Artificial Intelligence (AI) model. The method may further include generating a response corresponding to the input based on the retrieved information. The method may further include generating a plurality of prompts based on user characteristics and the input. The method may also include modifying the response based on the plurality of prompts to generate a multimodal response.

According to some example embodiments, the AI model is a Generative AI model.

According to some example embodiments, the method further comprises transmitting the multimodal response to the user, wherein the multimodal response is transmitted to the user in one or more combinations of modalities comprising text, speech, visual elements, and gesture.

According to some example embodiments, the method further comprises determining one or more modalities for generating the multimodal response based on user's engagement and comprehension levels.

According to some example embodiments, the AI model continuously learns from historical interactions to upgrade reasoning and response framing, and dynamically adapt user's accustomed communication style.

According to some example embodiments, the AI model employs a role-based approach following user-provided instructions and the plurality of prompts to generate the multimodal response.

According to some example embodiments, the AI model is trained to understand user emotions enabling generation of the multimodal response adaptive to user's emotional state.

According to some example embodiments, the plurality of prompts facilitates personalization of the response in real-time.

According to some example embodiments, the method further comprises storing a record of the input, the plurality of prompts, and the generated multimodal response for future reference and analysis.

According to some example embodiments, the method further comprises monitoring a user feedback on the multimodal response; adjusting subsequent prompts based on the user feedback; and modifying a subsequent response based on the subsequent prompts.

Some example embodiments disclosed herein provide a computer system for multimodal response generation through a virtual agent, the computer system comprises one or more computer processors, one or more computer readable memories, one or more computer readable storage devices, and program instructions stored on the one or more computer readable storage devices for execution by the one or more computer processors via the one or more computer readable memories, the program instructions comprising retrieving information related to an input received by the virtual agent. The virtual agent employs an Artificial Intelligence (AI) model. The one or more processors are further configured for generating a response corresponding to the input based on the retrieved information. The one or more processors are further configured for generating a plurality of prompts based on user characteristics and the input. The one or more processors are further configured for modifying the response based on the plurality of prompts to generate a multimodal response.

Some example embodiments disclosed herein provide a non-transitory computer readable medium having stored thereon computer executable instruction which when executed by one or more processors, cause the one or more processors to carry out operations for multimodal response generation through a virtual agent. The operations comprising retrieving information related to an input received by the virtual agent. The virtual agent employs an Artificial Intelligence (AI) model. The operations further comprising generating a response corresponding to the input based on the retrieved information. The operations further comprising generating a plurality of prompts based on user characteristics and the input. The operations further comprising modifying the response based on the plurality of prompts to generate a multimodal response.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present disclosure will become apparent upon consideration of the following detailed description of embodiments thereof, especially when taken in conjunction with the accompanying drawings, and wherein:

FIG. 1 illustrates a use case of a user interaction with a virtual agent, in accordance with an example embodiment;

FIG. 2 illustrates a block diagram of an electronic circuitry for multimodal response generation through a virtual agent, in accordance with an example embodiment;

FIG. 3 shows a flow diagram of a method for multimodal response generation through a virtual agent, in accordance with an example embodiment;

FIG. 4 illustrates a block diagram for multimodal response generation through a virtual agent, in accordance with an example embodiment;

FIG. 5 shows an exemplary scenario multimodal response generation through a virtual agent, in accordance with another example embodiment;

FIG. 6 a flow diagram of a method for multimodal response generation through a virtual agent, in accordance with another example embodiment;

FIG. 7 a flow diagram of a method for multimodal response generation through a virtual agent, in accordance with another example embodiment; and

FIG. 8 shows a flow diagram of a method for multimodal response improvement, in accordance with yet another example embodiment.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The term “machine learning model” may be used to refer to a computational or statistical or mathematical model that is trained on classical ML modelling techniques with or without classical image processing. The “machine learning model” is trained over a set of data and using an algorithm that it may use to learn from the dataset.

The term “artificial intelligence” may be used to refer to a model built using simple or complex Neural Networks using deep learning techniques and computer vision algorithms. Artificial intelligence model learns from the data and applies that learning to achieve specific pre-defined objectives.

The term “virtual agent” may be used to refer to a virtual assistant that is computer program or AI system designed to simulate human-like conversations with users. They are typically powered by artificial intelligence and natural language processing technologies. The virtual agent can understand user inputs, generate appropriate responses, and perform specific tasks or provide information. They are often used in customer support, information retrieval, and other applications to provide automated and efficient conversational experiences.

### End of Definitions

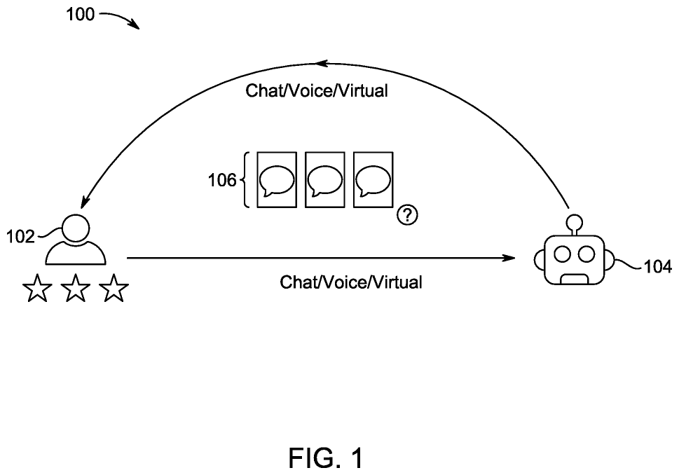

Embodiments of the present disclosure may provide a method, a system, and a computer program product for multimodal input processing for a virtual agent. The method, the system, and the computer program product for multimodal response generation through a virtual agent are described with reference to FIG. 1 to FIG. 8 as detailed below.

FIG. 1 illustrates a use case 100 of a user 102 interaction with a virtual agent 104, in accordance with an example embodiment. In an embodiment the interaction begins when the user 102 provides input to the virtual agent 104 through a medium 106. The user 102 may be, for example, a customer, client, or any other person seeking information or assistance through the virtual agent 104. The medium 106 is a conduit through which the user 102 and the virtual agent 104 exchange information. The medium 106 may take various forms, depending on the context of the interaction.

In some embodiments, the medium 106 supports multimodal communication, allowing the user 102 to combine various forms, such as text, speech, and visual elements. This multimodal capability enables a more natural and interactive communication between the user 102 and the virtual agent 104.

Furthermore, the medium 106 may involve sensor data, such as data from accelerometers, gyroscopes, GPS sensors, or other environmental sensors (e.g., temperature and humidity sensors). This environmental data plays important role in understanding user context and emotions, which is essential for generating personalized multimodal responses.

The user input, in this context, represents a query, request, or command from the user 102. This input serves as the starting point for the virtual agent 104 to understand the user's needs and provide appropriate assistance or information. Importantly, this input may span across various modalities, reflecting the diverse communication styles of users.

To further elaborate, here are some detailed examples of what these inputs may include:

Textual Input: The user may provide text-based queries or requests through written messages or chat. For instance: “Can you recommend a good Italian restaurant nearby?.”, or “Tell me today's weather forecast.”

Speech Input: Users may interact with the virtual agent 104 using spoken language. For instance: “Call John Smith.”, or “Play some relaxing music.”

Visual Input: Users may show their face expressions, emotions, or gestures, to show their feelings and the virtual agent 104 may interpret and respond to these inputs accordingly. For instance: A user might smile to indicate happiness or agreement.

Sensor Data: In scenarios involving IoT devices, wearable gadgets, or environmental sensors, the user's inputs may include data generated by these sensors. For example: health data from a fitness tracker, such as heart rate and steps taken, or home automation commands, like adjusting the thermostat temperature.

Commands and Requests: Users may issue direct commands or requests for specific actions. For example: “Set an alarm for 7 AM.”, or “Send a text message to Mom.”

Questions and Inquiries: Users often seek information or answers to questions. For example: “What's the capital of France?”, or “How do I bake a chocolate cake?”

Personal Preferences: Users may provide input related to their personal preferences or choices. For example: “Recommend a movie similar to the one I watched last week.”, or “Suggest a restaurant that serves vegetarian cuisine.”

Location-Based Queries: Input may involve location-based requests or queries. For example: “Find the nearest gas station.”, or “Give me directions to the nearest bus stop.”

In some embodiments, while communicating with the user 102, the virtual agent 104 may combine the multimodal inputs, such as text, speech, and visuals of the user to understand the user's query/request and provide more personalized response in visual form.

By way of an example, while communicating with the user 102, the virtual agent 104 may analyse the following:

Facial Expressions: Users may use their facial expressions to convey emotions or reactions. For instance: frowning or a furrowed brow may signify confusion or dissatisfaction, or raising an eyebrow may signal curiosity or scepticism.

Emotional Cues: Visual input as well as audio-based input and other forms of input help understand the emotional cues of the user. For example: if the user appears sad or teary-eyed, the agent can respond with empathy and offer comforting words, or the user 102 with an excited expression can prompt the agent to respond with enthusiasm.

Gestures: Users may use hand gestures or body language to communicate non-verbally. For example: pointing at an object in the environment, indicating interest or a question about that object, or waving a hand to get the agent's attention or to say goodbye.

Visual Cues: Users may provide visual cues by showing specific objects or scenes through their device's camera. For instance: displaying a broken appliance and asking for help in identifying the issue or sharing a photo of a product they want to purchase and asking for reviews or price information.

Facial Features: Detailed analysis of facial features, such as eye movements or the position of the mouth, may help gauge the user's emotional state or level of engagement. For example: dilated pupils may indicate excitement or interest, or avoiding eye contact might suggest shyness or discomfort.

The virtual agent 104, equipped with computer vision algorithms and advanced multimodal response generation techniques, may combine, and analyze these visual inputs to understand the user's intent, or emotions. This enables the virtual agent 104 to respond in a visual, personalized and contextually relevant manner, enhancing the overall user experience during interactions.

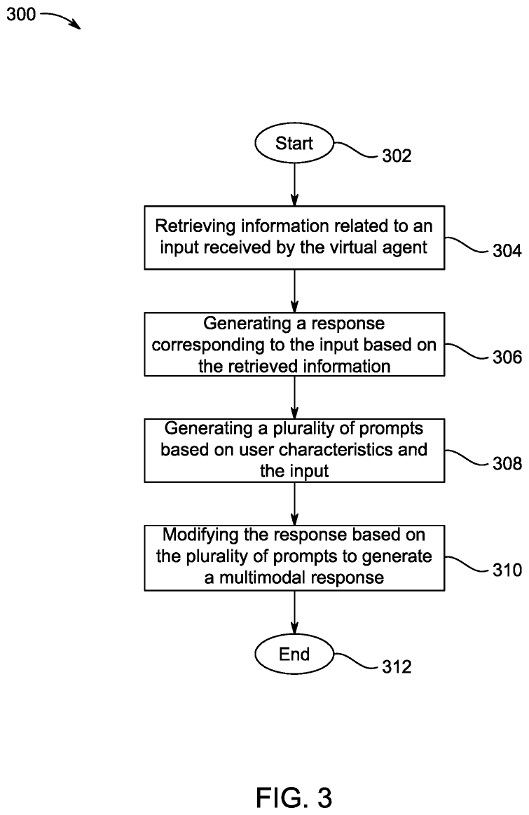

The ability to understand and respond to users across various modalities while considering individual user characteristics and emotions is a key differentiator and advantage of the present disclosure in the field of personalized multimodal response generation. This is further explained in greater detail in conjunction with FIGS. 3-8.

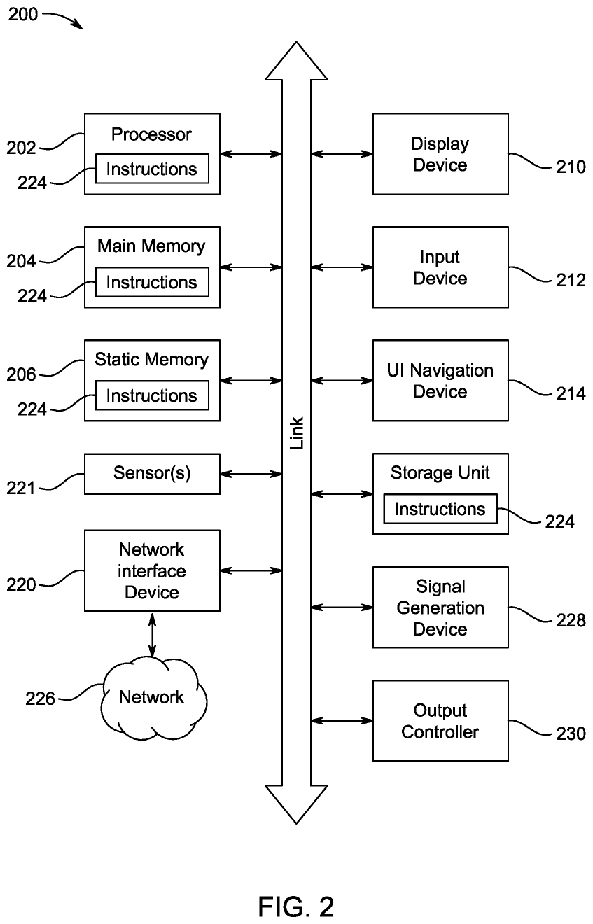

FIG. 2 illustrates a block diagram of an electronic circuitry for multimodal response generation through a virtual agent. The machine of FIG. 2 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 2 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

The example of the machine 200 includes at least one processor 202 (e.g., a central processing unit (CPU), a graphics processing unit (GPU), advanced processing unit (APU), or combinations thereof), one or more memories such as a main memory 204, a static memory 206, or other types of memory, which communicate with each other via link 208. Link 208 may be a bus or other type of connection channel. The machine 200 may include further optional aspects such as a graphics display unit 210 comprising any type of display. The machine 200 may also include other optional aspects such as an alphanumeric input device 212 (e.g., a keyboard, touch screen, and so forth), a user interface (UI) navigation device 214 (e.g., a mouse, trackball, touch device, and so forth), a storage unit 216 (e.g., disk drive or other storage device(s)), a signal generation device 218 (e.g., a speaker), sensor(s) 221 (e.g., global positioning sensor, accelerometer(s), microphone(s), camera(s), and so forth), output controller 228 (e.g., wired or wireless connection to connect and/or communicate with one or more other devices such as a universal serial bus (USB), near field communication (NFC), infrared (IR), serial/parallel bus, etc.), and a network interface device 220 (e.g., wired and/or wireless) to connect to and/or communicate over one or more networks 226.

Executable Instructions and Machine-Storage Medium: The various memories (i.e., 204, 206, and/or memory of the processor(s) 202) and/or storage unit 216 may store one or more sets of instructions and data structures (e.g., software) 224 embodying or utilized by any one or more of the methodologies or functions described herein. These instructions, when executed by processor(s) 202 cause various operations to implement the disclosed embodiments.

Example Machine Architecture and Machine-Readable Medium

FIG. 2 illustrates a representative machine architecture suitable for implementing the systems and so forth or for executing the methods disclosed herein. The machine of FIG. 2 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 2 is suitable to allow those of skill in the art to determine how to implement the embodiments previously described with an appropriate combination of hardware and software, with appropriate modification to the illustrated embodiment to the particular device, machine, etc. used.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include storage devices such as solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically and unequivocally excludes carrier waves, modulated data signals, and other such transitory media, at least some of which are covered under the term “signal medium” discussed below.

Signal Medium: The term “signal medium” shall be taken to include any form of modulated data signal, carrier wave, and so forth. The term “modulated data signal” means a signal that has one or more of its characteristics set or changed in such a matter as to encode information in the signal

Computer Readable Medium: The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

As used herein, the term “network” may refer to a long-term cellular network (such as GSM (Global System for Mobile Communication) network, LTE (Long-Term Evolution) network or a CDMA (Code Division Multiple Access) network) or a short-term network (such as Bluetooth network, Wi-Fi network, NFC (near-field communication) network, LoRaWAN, ZIGBEE or Wired networks (like LAN, el all) etc.).

As used herein, the term “computing device” may refer to a mobile phone, a personal digital assistance (PDA), a tablet, a laptop, a computer, VR Headset, Smart Glasses, projector, or any such capable device.

As used herein, the term ‘electronic circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

FIG. 3 shows a flow diagram of a method 300 for multimodal response generation through a virtual agent, in accordance with an example embodiment. It will be understood that each block of the flow diagram of the method 300 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 300 illustrated by the flowchart diagram of FIG. 3 shows the multimodal response generation through a virtual agent. Fewer, more, or different steps may be provided.

The method 300 starts at step 302, where the virtual agent is ready to retrieve the user input. At step 304, the virtual agent may retrieve information related to an input received by the virtual agent. This input may come in various forms, including text, speech, and visual cues. The virtual agent may employ an Artificial Intelligence (AI) model, which may, in particular embodiments, be a Generative AI (GenAI) model. The GenAI model represents a cutting-edge approach to artificial intelligence and is capable of multifaceted operations.

In specific implementations, the GenAI model may include, but not limited to, a Language model (LLM) for text, a Vision Language model (VLM) for vision-text, a speech model for speech, and other relevant modules. This comprehensive GenAI model is designed to process and respond to multimodal inputs effectively, making it exceptionally versatile in understanding and interacting with users across different modalities such as text, vision, and speech. In some embodiments, the GenAI model may take the form of an ensemble model allowing for even greater adaptability and proficiency in handling diverse inputs and user interactions.

At step 306, the method 300 may further include generation of a response corresponding to the input based on the retrieved information.

To further elaborate, before generating the response, the virtual agent thoroughly analyzes the user's input. This analysis includes understanding the content, context, intent, and sentiment conveyed by the user across various modalities, such as text, speech, and visual cues.

The virtual agent may refer to its knowledge base, which can be an internal database or an external data source, to gather additional information relevant to the user's query or input. This information retrieval process helps ensure that the response is factually accurate and contextually rich. Based on the analysis of the user's input and the retrieved information, the virtual agent generates an initial response. This response may take the form of text, speech, visual elements, or a combination of these modalities, depending on the nature of the user's input and the design of the virtual agent.

The virtual agent takes into account the user's characteristics, preferences, and historical interactions to tailor the response accordingly. For example, if the user has previously expressed a preference for a formal tone, the initial response may be composed in a formal style.

In scenarios where the user's input conveys emotional cues, such as sadness or frustration, the virtual agent may incorporate emotional intelligence. This means that the response may be designed to acknowledge the user's emotions and provide empathetic or supportive language.

At step 308, a plurality of prompts may be generated based on user characteristics and the input. The plurality of prompts facilitates personalization of the response in real-time. These prompts are created based on user characteristics and the content of the input. The prompts play a crucial role in guiding the subsequent response generation process.

In a more elaborative way, these prompts are designed to enhance personalization and ensure that the final multimodal response aligns with the user's individual characteristics, preferences, and the specific input provided. This may be achieved by the following steps:
User Characteristics Analysis: Before generating prompts, the virtual agent takes into account the user's characteristics, which may include factors like age, gender, cultural background, and historical interactions. This analysis helps the virtual agent to understand the user's preferences and communication style.
Input Consideration: The nature of the user's input is also a crucial factor in prompt generation. The virtual agent evaluates the input to identify any specific cues or elements that may be addressed or emphasized in the response.
Prompt Variability: To cater to diverse user preferences, the virtual agent generates multiple prompts. These prompts may vary in tone, style, and content, offering different approaches to modifying the response. For example, some prompts may encourage a more empathetic tone, while others may suggest a more informative or casual style.
Emotional Awareness: If the user's input contains emotional cues, such as expressions of sadness or frustration, the prompts may be created to reflect empathy and understanding. Emotional intelligence is used to ensure that the prompts are sensitive to the user's emotional state.
Contextual Relevance: The prompts generated are contextually relevant to both the user's input and their characteristics. They provide guidance on how to rephrase the response in a way that resonates with the user and addresses their specific needs.

Further, at step 310, the response may be rephrased based on the plurality of prompts to generate the multimodal response. In this step, the virtual agent selects an appropriate prompt from the plurality of prompts generated. The choice of prompt depends on several factors, including the user's characteristics, emotional state, and the specific context of the conversation.

By way of an example, consider a scenario where a user initiates a conversation with a virtual agent by saying, “I've been feeling really stressed lately due to work pressure. Can you help me manage my stress?”. Let's say the virtual agent selects the following prompt from the set: “I'm here to help you manage your stress. Let's start by discussing some relaxation techniques.”

The virtual agent uses this selected prompt as a foundation for its response to the user. However, it doesn't provide the prompt precisely. Instead, it rephrases it into a more comprehensive and empathetic response:
Original Prompt: “I'm here to help you manage your stress. Let's start by discussing some relaxation techniques.”
Rephrased Response: “I understand that work pressure may be incredibly stressful. I'm here to assist you in finding effective relaxation techniques that can help alleviate your stress. Let's explore some strategies together.”
Emotional Alignment: The rephrased response maintains alignment with the user's emotional state (stressed) and offers support and understanding.
Adaptability: Throughout the conversation, the virtual agent continually monitors the user's responses and adjusts its prompts and subsequent responses as needed. For example, if the user begins to share specific stressors, the agent may shift the conversation accordingly. The method 300 terminates at 312.

In some example embodiments, a computer programmable product may be provided. The computer programmable product may comprise at least one non-transitory computer-readable storage medium having stored thereon computer-executable program code instructions that when executed by a computer, cause the computer to execute the method 300.

In an example embodiment, an apparatus for performing the method 300 of FIG. 3 above may comprise a processor (e.g., the processor 202) configured to perform some or each of the operations of the method 300. The processor may, for example, be configured to perform the operations 302-312 by performing hardware implemented logical functions, executing stored instructions, or executing algorithms for performing each of the operations.

Alternatively, the apparatus may comprise means for performing each of the operations described above. In this regard, according to an example embodiment, examples of means for performing operations (302-312) may comprise, for example, the processor 202 which may be implemented in the system 200 and/or a device or circuit for executing instructions or executing an algorithm for processing information as described above.

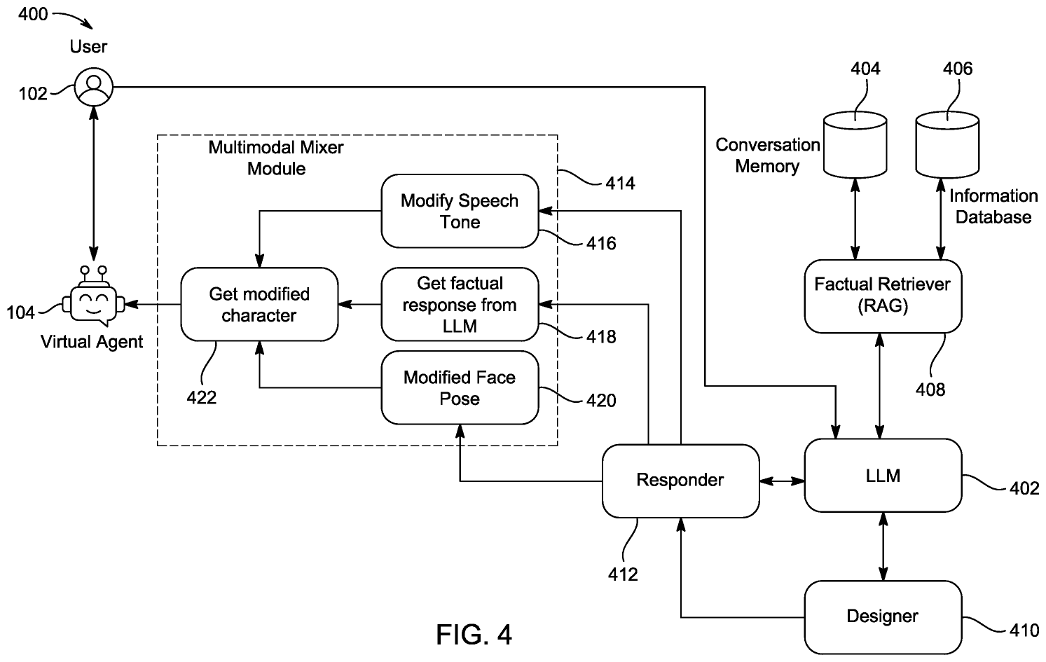

FIG. 4 illustrates a block diagram 400 for multimodal response generation through a virtual agent, consistent with embodiments of the present disclosure. This block diagram 400 demonstrates a process of generating a personalized multimodal response by the virtual agent 104, taking into account the user's input, historical interactions, and communication preferences. The process begins when the user 102 asks question/query, or guidance and/or advice to the virtual agent 104 in various forms, including text, speech, visual cues, emotions, and gestures.

The user query may include a wide range of topics, including but not limited to:
Information Seeking: Users may seek answers to factual questions, such as inquiries about current events, historical facts, or general knowledge.
Emotional Expression: Users may express their emotions, sharing feelings of happiness, sadness, frustration, or excitement. These expressions may be accompanied by text, voice, and facial cues.
Advice and Guidance: Users may seek advice or guidance on personal or professional matters, such as relationship advice, career decisions, or lifestyle choices.
Task Execution: Queries may involve task-oriented requests, such as setting reminders, sending messages, or performing specific actions within the virtual agent's capabilities.
Entertainment: Users may engage in light-hearted or entertaining conversations, requesting jokes, riddles, or engaging in storytelling.

The multimodal nature of user query ensures that the virtual agent 104 may accommodate a wide array of communication styles and user preferences, making the interaction not only efficient but also personalized and engaging. This flexibility enables the virtual agent 104 to provide a diverse user needs and advance meaningful interactions across various domains and scenarios.

In the backend, while answering to the user's query the virtual agent 104 may include various components that may perform various functionalities:
GenAI model: The GenAI model may include, but not limited to, a Language model (LLM) 402 for text, a Vision Language model (VLM) for vision-text, a speech model for speech, and other relevant modules. This comprehensive GenAI model is designed to process and respond to multimodal inputs effectively, making it exceptionally versatile in understanding and interacting with users across different modalities such as text, vision, and speech. In some embodiments, the GenAI model may take the form of an ensemble model allowing for even greater adaptability and proficiency in handling diverse inputs and user interactions.
LLM 402: The LLM 402 may be capable of processing multimodal user's query. The LLM 402 is an important component that handles the understanding and interpretation of the user's query using natural language processing techniques. Additionally, the LLM 402 may take inputs from conversation memory 404 and information database 406 via factual retrieval 408 for further processing.
The conversation memory 404: It stores relevant information within the current interaction cycle. It allows the virtual agent 104 to maintain context and recall information during the ongoing conversation.
The information database 406: It includes related information from private or public database that includes the references needed to answer the question, customized by the conversation memory 404.
The factual retriever (Retrieval Augmented Generation (RAG)) 408: It is responsible for retrieving relevant information from private or public databases. It does so by referring to the references needed to answer the user's question. The retrieved information is customized based on the conversation history stored in the conversion memory 404.
Designer 410: The designer 410 receives input from the LLM 402 and user's characteristics and question. Its role is to design short prompts or instructions that guide the responder 412 in modifying the answer to make it more personalized and aligned with the user's style.
Responder 412: The responder 412 takes the prompts or instructions provided by the designer 410 and uses them to generate a response to the user's question. This response is personalized to suit the user communication style and preferences, enhancing the overall user experience.
Multimodal Mixer Module 414: The multimodal mixer module 414 is responsible for delivering the final response to the user 102. Depending on the specified output modalities, it may combine various elements to create a multimodal response that includes text (user request/question), vision (facial expression), and audio (tone of speech).

Based on the user's voice, emotions and character, the virtual agent may customize it's speech tone, face pose and its character. Therefore, to achieve this, the multimodal mixer module 414 may include components such as speech tone modifier 416, the factual information retrieved and delivered as natural language 418, and face pose modifier 420.

The speech tone modifier may be capable of modifying speech tone of the virtual agent 416. This allows the virtual agent to convey the response with the desired emotional tone or style.

The factual information retriever 418 component retrieves factual information from the LLM 402 to ensure that the response is grounded in accurate data and facts. The retrieved information is presented as natural language in order to respond back to the user.

The face pose modifier 420 component focuses on adjusting the virtual agent's facial expression, which may be included in the visual aspect of the response.

The components for modifying speech tone, retrieving factual responses, and adjusting facial expressions work together to generate a modified character of the virtual agent 104 via a character generator 422. This character represents the virtual agent's response and is designed to convey the information effectively.

Finally, the modified character, which encapsulates the multimodal response, is transmitted to the user 102 through the virtual agent 104. The response is tailored to include text, visual elements, and speech, enhancing the overall user-agent interaction.

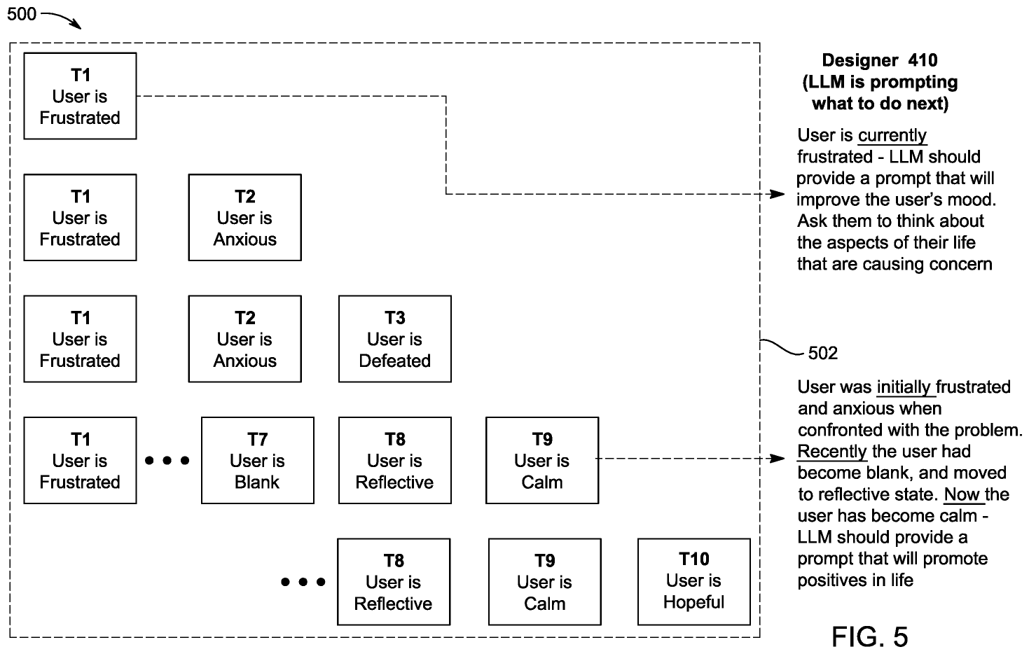

For the sake of explanation of multimodal response generation process, consider an exemplary scenario 500 of user and virtual agent interaction, as illustrated in FIG. 5. The engagement begins with the Large Language Model (LLM) observing user's thoughts 502 throughout the conversation, from start to finish. The LLM tracks changes in the user's emotional state over time. For example, it may observe that the user initially feels frustrated but eventually becomes more hopeful, as depicted in FIG. 5.

In a more elaborate way, the virtual agent in conjunction with LLM may do the following observation by looking at the user: User feels a bit low and anxious. Eyes not looking straight. Speech is very feeble. The LLM collects the following information related to the user's feeling: the user is feeling low and anxious, the user's eyes are not looking straight, and the user's speech is very feeble.

Further, the user may ask multimodal query, “Will things get better for me in life?”. The multimodal input includes text (typing), voice (spoken words), and visual cues (facial expression and gestures) to convey their emotional state.

Based on user's query and the collected emotional information, the designer comes into play. The LLM collaborates with the designer to devise a prompt aimed at exploring the user's current emotional state and identifying the aspects of their life that are causing concern. This prompt is designed to improve the user's mood and emotional well-being, aligning with the observed emotional journey information. For example, as shown in present FIG. 5, after observing that the user is currently frustrated, the LLM is prompting what to do next. In particular, the LLM guides the designer 410 to design a prompt that may improve the user's mood.

Subsequently, the responder uses text to prompt the user to share their feelings. It expresses empathy and understanding, acknowledging the user's emotions. Furthermore, the responder adjusts its speech tone to be more empathetic, matching the user's emotional state, and lowering it accordingly. Simultaneously, in the visual aspect, the virtual agent displays an empathetic facial expression, reinforcing the supportive and understanding nature of the response.

In light of the user's expressed feelings of being low and anxious, along with their eyes and speech as indicators of emotional intensity, the virtual agent responds with a compassionate message. It states, “I'm sorry to hear you're feeling low and anxious. Acknowledging your emotions and taking care of yourself is crucial. Your eyes and speech may reflect the intensity of your feelings. To give a better answer, I need more context. Life has its ups and downs; seeking support from friends, family, or a counselor can help. You're not alone; don't hesitate to ask for help. Take small steps in self-care and find joy in activities. While I can't predict the future, I'm here to support you. Feel free to share more, and remember, talking about your feelings is the first step to positive change.”

Following this response, the virtual agent continues to monitor the user's emotional state and designs prompts accordingly. For example, in the depicted scenario, the user transitions from initial frustration and anxiety to a blank and reflective state and eventually to a state of calm. The LLM guides the designer to provide prompts that encourage positive thinking and outlook in life, facilitating a personalized and empathetic interaction.

In a more generalized way, the interaction between the user and the virtual agent may be explained with the help of another example where the virtual agent persona is created beforehand. The details of the created virtual agent are follows:
Name: Jason
Age group: 30
Gender: Male
Country: Australia
Hobbies: Playing basketball, photography, and cooking

The user begins conversation with the virtual agent named “Jason” as follows:
User: I feel today is not my day!
Jason (as your best friend): Aw, I can sense it from your tone. Tell me, what happened?
User response with Mood: Frustrated and Interest level: Engaged
User: Ugh, everything just seemed to go wrong today. I woke up late, spilled coffee on my shirt, and missed an important meeting!
Jason (understanding): I feel you! Mornings like that are a nightmare. And missing a meeting can be stressful.
User response with Mood: Relatable and Interest level: Engaged
User: It's like the universe conspired against me. Then, my computer crashed, and I lost all my work! I can't catch a break!
Jason (sympathetic): That's tough luck! Losing work is the worst feeling, and it's totally unfair.
User response with Mood: Anxious and Interest level: Engaged User: I'm just so fed up! Nothing seems to be going my way, and I'm losing hope.
Jason (supportive): I get it. It's okay to feel that way, but remember, bad days don't last forever.
User response with Mood: Defeated and Interest level: Engaged
User: I know, but it's hard to see the light at the end of the tunnel right now. Jason (encouraging): It's completely understandable. But you're strong, and you've overcome tough times before. Remember all those victories.
User response: Mood: Reflective Interest level: Engaged Me: Yeah, you're right. I've faced challenges before, and I came out stronger.
Jason (reassuring): Exactly! This is just another bump in the road. Take a deep breath, and let's think of something positive.
User response with Mood: Calmer and Interest level: Engaged
User: I could use some positivity right now.
Jason (cheerful): That's the spirit! How about we plan something fun for the weekend? A mini getaway or trying out a new activity?
User response with Mood: Interested and Interest level: Engaged
User: That sounds like a great idea! I could use a break and some excitement.
Jason (energetic): Awesome! We'll turn this day around and make the weekend unforgettable. You've got this!
User response with Mood: Hopeful and Interest level: Engaged
User: Thanks, Jason. You're the best friend anyone could have.

This example showcases the effectiveness of a virtual agent like Jason in understanding and responding to the user's changing emotional states. Jason's persona, empathetic responses, and adaptability help to transform the user's negative emotions into a more positive and hopeful outlook. The engagement level is consistently maintained throughout the conversation, demonstrating a personalized and emotionally intelligent interaction.

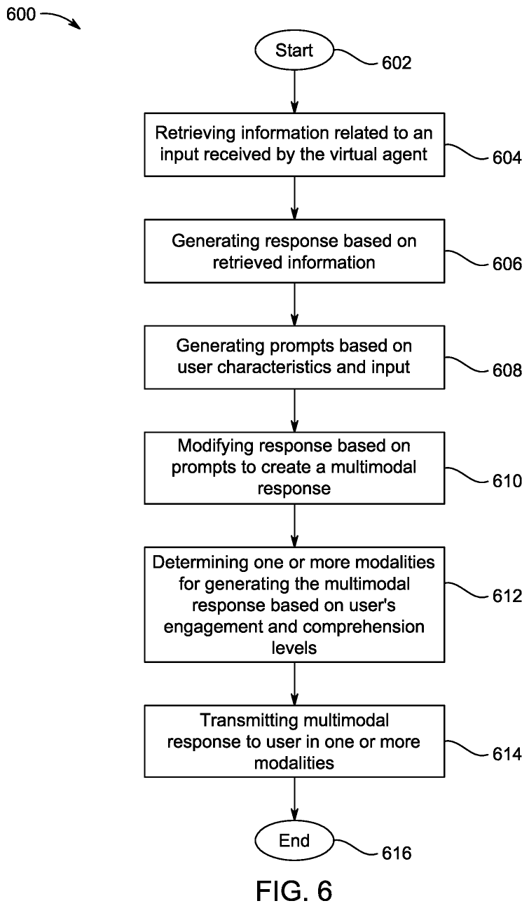

FIG. 6 illustrates a method 600 for multimodal response generation through a virtual agent, in accordance with another example embodiment. It will be understood that each block of the flow diagram of the method 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of the system 200, employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 600 illustrated by the flow diagram of FIG. 600 for multimodal response generation through a virtual agent starts at 602. The method 600 may include, at step 604, retrieving information related to an input received by the virtual agent. The virtual agent may employ an Artificial Intelligence (AI) model. In some embodiments, the AI model may be a Generative AI (GenAI) model. The GenAI model represents a cutting-edge approach to artificial intelligence and is capable of multifaceted operations.

In specific implementations, the GenAI model may include, but not limited to, a Language model (LLM) for text, a Vision Language model (VLM) for vision-text, a speech model for speech, and other relevant modules. This comprehensive GenAI model is designed to process and respond to multimodal inputs effectively, making it exceptionally versatile in understanding and interacting with users across different modalities such as text, vision, and speech. In some embodiments, the GenAI model may take the form of an ensemble model allowing for even greater adaptability and proficiency in handling diverse inputs and user interactions. It should be noted that the multimodal input processing may be enhanced by utilizing either a single model, or an ensemble of models designed to specific modalities, such as text, voice, and visual inputs. These models play an important role in converting the multimodal inputs into a standardized format before presenting them to the collector for entity recognition and extraction.

Once the information is retrieved, method 600 may further include, at step 606, generating a response corresponding to the input based on the retrieved information. Further, the method 600, at step 608, may include generating a plurality of prompts based on user characteristics and the input. Subsequently, at step 610, the method 600 includes modifying the response based on the plurality of prompts to generate a multimodal response. This is already explained in conjunction with FIG. 3.

Further, at step 612 the method 600 may include determining one or more modalities for generating the multimodal response based on user's engagement and comprehension levels. In this step, the virtual agent assesses the user's engagement and comprehension levels to make informed decisions about the modalities to be used when generating the multimodal response. The choice of modalities is adapted to the user's preferences and needs, aiming to provide the most effective and engaging interaction. The one or more modalities may be determined by the following steps:
User Engagement and Comprehension: The virtual agent continuously monitors the user's interaction throughout the conversation. It observes factors like the user's responsiveness, attention, and level of involvement. Additionally, it assesses the user's comprehension of the ongoing dialogue, ensuring that the conversation remains coherent and understandable.
Adaptive Modality Selection: Based on the observed engagement and comprehension levels, the virtual agent dynamically determines which modalities to employ in the multimodal response. These modalities may include text, speech, visual elements, and gestures. The agent aims to choose the modalities that align with the user's preferences and the specific context of the conversation.
Enhancing User Experience: The primary goal of this step is to enhance the user experience by tailoring the response to the user's current state and communication preferences. For instance, if the user appears to be more responsive to visual cues, the response may include images or gestures. Alternatively, if the user prefers text-based communication, the response may focus on textual content.
Personalization: The adaptive selection of modalities adds a layer of personalization to the interaction. By considering the user's engagement and comprehension levels, the virtual agent ensures that the response is not only relevant but also presented in a way that resonates with the user's communication style and preferences.
Flexibility: The virtual agent remains flexible in its approach, ready to adjust the choice of modalities as the conversation progresses. This adaptability ensures that the response remains effective and engaging, regardless of changes in the user's behaviour or preferences.

After generating the multimodal response, at step 614 the method 600 may include transmitting the multimodal response to the user. The multimodal response is transmitted to the user in one or more combinations of modalities comprising text, speech, visual elements, and gesture. This ensures that the user receives the response in a format that suits their preferences and needs. The method 600 may be terminated, at step 616.

In some example embodiments, a computer programmable product may be provided. The computer programmable product may comprise at least one non-transitory computer-readable storage medium having stored thereon computer-executable program code instructions that when executed by a computer, cause the computer to execute the method 600.

In an example embodiment, an apparatus for performing the method 600 of FIG. 6 above may comprise a processor (e.g., the processor 202) configured to perform some or each of the operations of the method 600. The processor may, for example, be configured to perform the operations 602-516 by performing hardware implemented logical functions, executing stored instructions, or executing algorithms for performing each of the operations. Alternatively, the apparatus may comprise means for performing each of the operations described above. In this regard, according to an example embodiment, examples of means for performing operations (602-616) may comprise, for example, the processor 202 which may be implemented in the system 200 and/or a device or circuit for executing instructions or executing an algorithm for processing information as described above.

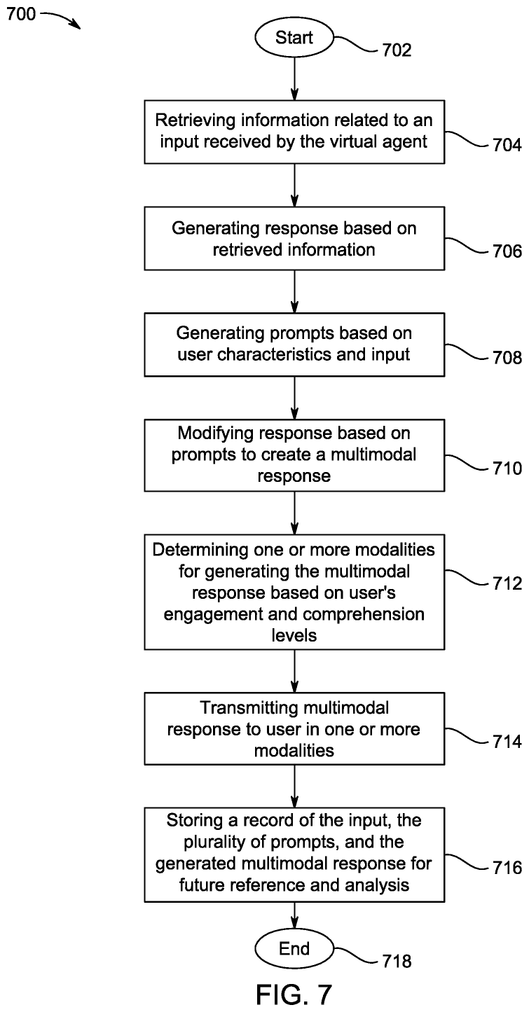

FIG. 7 shows a flow diagram of a method 700 for multimodal input processing for a virtual agent, in accordance with another example embodiment. It will be understood that each block of the flow diagram of the method 700 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 600 illustrated by the flowchart diagram of FIG. 7 shows a method for multimodal response generation through a virtual agent. Fewer, more, or different steps may be provided.

The method 700 starts at 702 and commences with retrieving information related to an input received by the virtual agent, at step 704. The virtual agent may employ an Artificial Intelligence (AI) model. In some embodiments, the AI model may be a. Generative AI (GenAI) model. Examples of the GenAI may include, but are not limited to, LLM, VLM, and the like. In some embodiments, the Gen AI may be an ensemble model.

Once the information is retrieved, method 700 may further include, at step 706, generating a response corresponding to the input based on the retrieved information. Further, the method 700, at step 708, may include generating a plurality of prompts based on user characteristics and the input. Subsequently, at step 710, the method 700 includes modifying the response based on the plurality of prompts to generate a multimodal response.

Further, at step 712 the method 700 may include determining one or more modalities for generating the multimodal response based on user's engagement and comprehension levels. Further, at step 714 the method 700 may include transmitting the multimodal response to the user. The multimodal response is transmitted to the user in one or more combinations of modalities comprising text, speech, visual elements, and gesture.

Furthermore, at step 716 the method 700 may include storing a record of the input, the plurality of prompts, and the generated multimodal response for future reference and analysis. At this stage, the virtual agent ensures that a comprehensive record of the conversation is maintained. This record includes the user's original input, the prompts that were generated based on the user's characteristics and input, and the final multimodal response. This data is valuable for several reasons:
Analysis and Evaluation: By storing this data, the virtual agent can perform post-interaction analysis. It may assess the quality and effectiveness of the responses provided to the user. This analysis may involve evaluating the relevance of prompts, the appropriateness of the selected modalities, and the overall impact on user engagement and satisfaction.
Feedback and Learning: The stored records also facilitate ongoing learning and improvement of the virtual agent. The virtual agent may use this data to identify patterns in user interactions and tailor its responses more effectively in future conversations. For instance, if certain prompts consistently lead to better user engagement, the agent may prioritize using similar prompts in similar situations.
User History: Over time, the stored records accumulate to create a historical archive of user interactions. This user history may be utilized to provide more personalized responses in subsequent interactions. The virtual agent may reference past conversations to understand the user's preferences, communication style, and evolving needs.
Future Reference: Storing these records ensures that the virtual agent may refer back to previous interactions when needed. This may be helpful in cases where the user returns with follow-up questions or requests related to past discussions. Having access to this historical data enables the agent to maintain context and provide more coherent responses.
Transparency and Accountability: Storing records also adds a layer of transparency to the interaction. If users have questions or concerns about their previous interactions with the virtual agent, the stored records can be referenced to address their queries or provide clarification.
Compliance and Security: Depending on the context of the interactions, maintaining records may be necessary for compliance with data protection regulations or for security purposes. The virtual agent ensures that these records are appropriately managed and secured. The method 700 may be terminated, at step 718.

In some example embodiments, a computer programmable product may be provided. The computer programmable product may comprise at least one non-transitory computer-readable storage medium having stored thereon computer-executable program code instructions that when executed by a computer, cause the computer to execute the method 700.

In an example embodiment, an apparatus for performing the method 700 of FIG. 7 above may comprise a processor (e.g., the processor 202) configured to perform some or each of the operations of the method 700. The processor may, for example, be configured to perform the operations (702-718) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (702-718) may comprise, for example, the processor 202 which may be implemented in the system 200 and/or a device or circuit for executing instructions or executing an algorithm for processing information as described above.

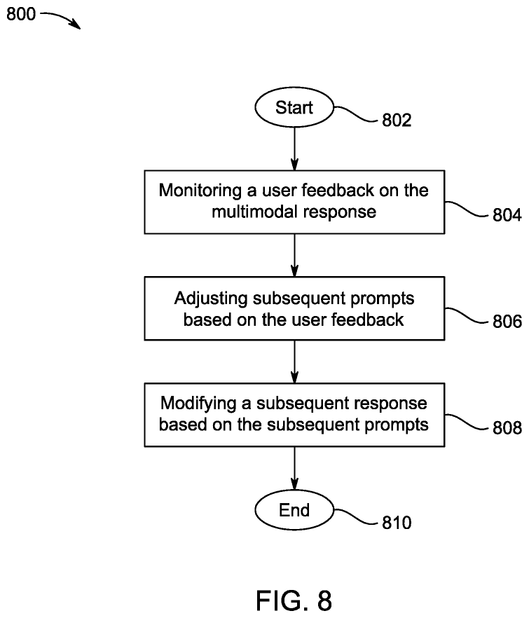

FIG. 8 illustrates a method 800 for multimodal response refinement based on user feedback, in accordance with yet another example embodiment. It will be understood that each block of the flow diagram of the method 800 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of the system 200, employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 800 illustrated by the flow diagram of FIG. 8 for multimodal response refinement may start at step 802 and at step 804, the method 800 may include monitoring a user feedback on the multimodal response. The user feedback may include:
User Ratings: Users may provide numerical ratings or feedback scores after interacting with the virtual agent. These ratings help quantify the user's satisfaction or dissatisfaction with the responses.
User Comments: Users may offer qualitative comments or suggestions regarding their interactions. These comments provide valuable information related to specific issues, preferences, or areas for improvement.
Emotional Feedback: The virtual agent may also analyze the user's emotional cues during the interaction, such as tone of voice, facial expressions, or gestures, to gauge the user's emotional state and overall experience.
Engagement Metrics: Metrics like interaction duration, response times, or the number of queries made by the user may indicate the user's level of engagement and satisfaction.

Further the method 800 may include, at step 806, adjusting subsequent prompts based on the user feedback. The primary objective is to adapt the prompts and instructions used in generating responses to better align with the user's preferences and emotional states. This may be achieved by following steps:
Feedback Analysis: The feedback obtained from the user is analyzed to understand specific areas where improvements are needed. This analysis may involve looking for patterns in user comments, ratings, emotional cues, or engagement metrics.
Prompt Refinement: Based on the feedback analysis, the virtual agent's designer, responsible for creating prompts and instructions, makes adjustments to the prompts used in generating responses. These prompts are designed to obtain specific information or guide the user's responses in a way that leads to more effective and satisfying interactions.
Personalization: The prompts may be personalized to suit the user's individual characteristics, preferences, and emotional states. For example, if the user often expresses frustration, prompts may be adjusted to use a more calming and empathetic tone.
Continuous Learning: The virtual agent employs machine learning techniques to continuously learn from user feedback and adapt its prompt-generation strategy over time. This allows it to become more proficient at tailoring prompts to individual users.

By adjusting subsequent prompts based on user feedback, the virtual agent aims to create a more user-centric and emotionally aware interaction environment. This adaptive approach helps improve user engagement and satisfaction by addressing specific concerns and preferences expressed by the user during interactions.

Further, the method 800, at step 808, may include modifying a subsequent response based on the subsequent prompts. By modifying responses to align with the user's emotional state and preferences, the virtual agent tries to create a more meaningful and satisfying interaction. This iterative process contributes to the virtual agent's ability to provide empathetic and contextually relevant responses. The method 800 terminates at step 810.

Capturing user emotions/information at frequent intervals in a sliding window (each conversation) and then tracking whether the user behavior has improved/changed positively or negatively over time.

In some embodiments, in order to improve the generated response, a temporal observation and user analysis may be performed by the LLM that involve continuously capturing user emotions and information at frequent intervals, typically after each conversation or interaction, and then tracking how the user's behavior, emotions, or overall state change over time. This process aims to understand how the language model's responses, along with various data inputs, influence the user's experience and well-being. The temporal observation and user analysis facilitates:
Adaptive Responses: As the language model (LLM) observes changes in the user's behavior over time, it may dynamically adapt its responses to suit the user's evolving preferences and emotional states. This adaptive approach enhances the user experience and builds a stronger bond between the user and the language model. By
Monitoring Progress: Over time, the language model may track improvements in the user's interactions, emotional well-being, or even their personal development based on the positive effects of using the system. This progress monitoring may serve as an indicator of the language model's efficacy and its positive impact on the user.
Continuous Improvement: The process of temporal observation and user analysis fosters a continuous feedback loop, allowing the language model to constantly improve its responses and adapt to changing user needs and preferences.

In some example embodiments, a computer programmable product may be provided. The computer programmable product may comprise at least one non-transitory computer-readable storage medium having stored thereon computer-executable program code instructions that when executed by a computer, cause the computer to execute the method 800.

In an example embodiment, an apparatus for performing the method 800 of FIG. 8 above may comprise a processor (e.g., the processor 202) configured to perform some or each of the operations of the method 800. The processor may, for example, be configured to perform the operations (802-810) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (802-810) may comprise, for example, the processor 202 which may be implemented in the system 200 and/or a device or circuit for executing instructions or executing an algorithm for processing information as described above.

As will be appreciated by those skilled in the art, the techniques described in the various embodiments discussed above are not routine, or conventional, or well understood in the art. The present disclosure addresses the limitations of existing techniques in multimodal response generation through a virtual agent. Unlike conventional approaches that often rely solely on text-based input, the disclosed techniques enable virtual agents to generate multimodal response. Users may communicate through text, speech, and visual cues, making interactions more natural and accommodating diverse user preferences. By utilizing an LLM in conjunction with a role-based approach and continuous monitoring of user engagement and satisfaction, the disclosed techniques represent a novel and highly innovative approach to enhancing the capabilities of virtual agents.

The techniques discussed above provide various advantages that may significantly enhance both personal and professional aspects of life. By introducing a personalized, skill-focused virtual agent that leverages Large Language Models (LLMs) and multimodality, these advancements open doors to an entirely new level of user interaction. This virtual agent may be a game-changer in various domains, providing a host of benefits.

First and foremost, these techniques have the potential to revolutionize the customer experience by enabling live interactions and personalization. Users can expect a level of engagement and assistance that goes beyond traditional AI systems. This personalized touch may lead to improved satisfaction, making interactions more meaningful and productive.

One of the standout advantages is the boost in productivity across different tasks and domains. Whether it's at work or in daily life, the virtual agent's capabilities translate to faster task completion, saving valuable time and resources. This efficiency gain may have a significant impact on overall work productivity and life management.

Moreover, these techniques enable the creation of a virtual agent with diverse personas, providing a multi-dimensional view and understanding of user needs and preferences. This versatility ensures that the virtual agent may adapt to various roles and scenarios, catering to a wide range of user requirements.

The incorporation of factual evidence through retrieval augmented generation is another noteworthy advantage. This means that the virtual agent may access and utilize relevant information from internal and external sources, enhancing its ability to provide accurate and informed responses.

Furthermore, these techniques promote internal information sharing across different functionalities, fostering collaboration and knowledge exchange within the virtual agent system. This collective intelligence can result in more comprehensive and contextually relevant responses.

Lastly, these advancements enable interactive and responsible conversations with users, taking into account their previous history and interactions. This level of continuity and context-awareness creates a more engaging and meaningful user-agent relationship.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

What is claimed is:

1. A computer-implemented method for multimodal response generation through a virtual agent comprising:
retrieving information related to an input received by the virtual agent, wherein the virtual agent employs an Artificial Intelligence (AI) model;
generating a response corresponding to the input based on the retrieved information;
generating a plurality of prompts based on user characteristics and the input; and
modifying the response based on the plurality of prompts to generate a multimodal response.

2. The computer-implemented method of claim 1, further comprising:
transmitting the multimodal response to the user, wherein the multimodal response is transmitted to the user in one or more combinations of modalities comprising text, speech, visual elements, and gesture.

3. The computer-implemented method of claim 1, wherein the AI model is a Generative AI model.

4. The computer-implemented method of claim 1, further comprising determining one or more modalities for generating the multimodal response based on user's engagement and comprehension levels.

5. The computer-implemented method of claim 1, wherein the AI model continuously learns from historical interactions to upgrade reasoning and response framing, and dynamically adapt user's accustomed communication style.

6. The computer-implemented method of claim 1, wherein the AI model employs a role-based approach following user-provided instructions and the plurality of prompts to generate the multimodal response.

7. The computer-implemented method of claim 1, wherein the AI model is trained to understand user emotions enabling generation of the multimodal response adaptive to user's emotional state.

8. The computer-implemented method of claim 1, wherein the plurality of prompts facilitate personalization of the response in real-time.

9. The method of claim 1, further comprising storing a record of the input, the plurality of prompts, and the generated multimodal response for future reference and analysis.

10. The method of claim 1, further comprising:
monitoring a user feedback on the multimodal response;
adjusting subsequent prompts based on the user feedback; and
modifying a subsequent response based on the subsequent prompts.

11. A computer system for multimodal response generation through a virtual agent comprising, the computer system comprising: one or more computer processors, one or more computer readable memories, one or more computer readable storage devices, and program instructions stored on the one or more computer readable storage devices for execution by the one or more computer processors via the one or more computer readable memories, the program instructions comprising:
retrieving information related to an input received by the virtual agent, wherein the virtual agent employs an Artificial Intelligence (AI) model;
generating a response corresponding to the input based on the retrieved information;
generating a plurality of prompts based on user characteristics and the input; and
modifying the response based on the plurality of prompts to generate a multimodal response.

12. The system of claim 10, wherein the program instructions further comprising transmitting the multimodal response to the user, wherein the multimodal response is transmitted to the user in one or more combinations of modalities comprising text, speech, visual elements, and gesture.

13. The system of claim 10, wherein the AI model is a Generative AI model.

14. The system of claim 10, wherein the program instructions further comprising determining one or more modalities for generating the multimodal response based on user's engagement and comprehension levels.

15. The system of claim 10, wherein the AI model continuously learns from historical interactions to upgrade reasoning and response framing, and dynamically adapt user's accustomed communication style.

16. The system of claim 10, wherein the AI model employs a role-based approach following user-provided instructions and the plurality of prompts to generate the multimodal response.

17. The system of claim 10, wherein the AI model is trained to understand user emotions enabling generation of the multimodal response adaptive to user's emotional state.

18. The system of claim 10, wherein the plurality of prompts facilitates personalization of the response in real-time.

18. The system of claim 10, wherein the program instructions further comprising storing a record of the input, the plurality of prompts, and the generated multimodal response for future reference and analysis.

19. The system of claim 10, wherein the program instructions further comprising:
monitoring a user feedback on the multimodal response;
adjusting subsequent prompts based on the user feedback; and
modifying a subsequent response based on the subsequent prompts.

20. A non-transitory computer-readable storage medium having stored thereon computer executable instruction which when executed by one or more processors, cause the one or more processors to carry out operations for multimodal response generation through a virtual agent, the operations comprising perform the operations comprising:
retrieving information related to an input received by the virtual agent, wherein the virtual agent employs an Artificial Intelligence (AI) model;
generating a response corresponding to the input based on the retrieved information;
generating a plurality of prompts based on user characteristics and the input; and
modifying the response based on the plurality of prompts to generate a multimodal response.
